(19) United States
(12) Patent Application Publication
(10) Pub. No.: US 2017/0112105 A1
(43) Pub. Date: Apr. 27, 2017

(54) HARNESS AND LEASH FOR BIRDS

(71) Applicant: AvianWeb, LLC, Mims, FL (US)

(72) Inventor: Sibylle Johnson, Mims, FL (US)

(21) Appl. No.: 15/299,393

(22) Filed: Oct. 20, 2016

Related U.S. Application Data
(60) Provisional application No. 62/243,976, filed on Oct. 20, 2015.

(51) Int. Cl. A01K 37/00; A01K 15/04; A01K 27/00; A01K 45/00

(52) U.S. Cl. CPC A01K 37/00; A01K 45/00; A01K 15/04; A01K 27/002; A01K 27/005

(57) ABSTRACT

A harness and leash for birds. The harness having a rounded neck loop. The rounded neck loop formed within a body portion of the harness. The body portion having abdomen belt attachment points configured to receive an abdomen belt. A leach attachment ring can slide along the abdomen belt.

### FIELD OF THE DISCLOSURE

This disclosure generally relates to bird harnesses and in particular, bird harnesses that can facilitate flight of birds.

### BACKGROUND

Harnesses for birds are typically made of a string or thin cable material which causes the harnesses to rub and chafe underneath the wings of birds. This causes the birds discomfort. Birds tend not to tolerate harnesses because of the discomfort caused by bird harnesses.

Bird harnesses tend to include quick-release attachments for leashes that birds can easily undo, allowing the birds to detach the leash and fly away.

### SUMMARY

One aspect of the disclosure relates to a harness for use with birds. Another aspect of the disclosure relates to a detachable leash for use with a bird harness. The leash can be configured to facilitate the detachment of the leash from the harness. The leash can be configured to facilitate secure reattachment of the leash while avoiding the risk of pet birds being able to detach the leash.

Prior art bird harnesses can include quick release attachment systems which are easily removable by birds, thereby allowing them to detach themselves from the leash and fly away. This is a major hurdle with prior art bird harnesses.

The presently described bird harness is configured to be more comfortable around the neck and upper body of the bird.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is an illustration of a leash for use with a bird harness having one or more elements consistent with the present description;

FIG. 2 is an illustration of a leash for use with a bird harness having one or more elements consistent with the present description;

FIGS. 3A-3B illustrate a bird harness having one or more elements consistent with the present description; and

FIG. 4 is an illustration of a bird harness having one or more elements consistent with the present description.

### DETAILED DESCRIPTION

Harnesses for birds are typically made of a string or thin cable material which causes the harnesses to rub and chafe underneath the wings of birds. This causes the birds discomfort. Birds tend not to tolerate harnesses because of the discomfort caused by bird harnesses. Bird harnesses tend to include quick-release attachments for leashes that birds can easily undo, allowing the birds to detach the leash and fly away.

The presently described subject matter provides a bird harness and leash system where birds cannot remove the leash easily and where the harness is configured to be comfortable for the birds to wear.

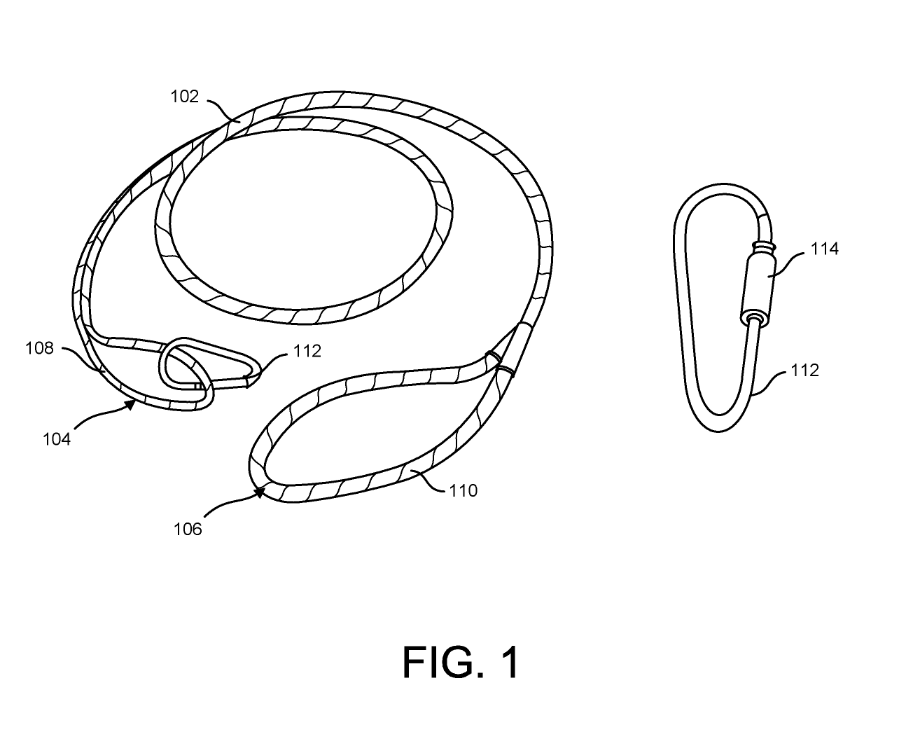

FIG. 1 illustrates a leash 102 for use with a bird harness having one or more features consistent with the present description. The leash 102 can be formed of an elastic material. The leash 102 can be formed of a lightweight material. In some variations, the leash 102 can be made from one or more of webbing, parachute cord, or the like. The leash 102 can be made from different materials based on the weight, size and strength of the bird for which it is intended. For example, for larger birds, military strength parachute cord can be used, parachute cord can have a tensile strength, for example, of 100 lb, 200 lb, 300 lb, 400 lb or more. The parachute cord can be configured to hold up to powerful beaks attempting to cut the parachute cord. For smaller birds, a lighter material can be used. The lighter material can be configured to facilitate flight by the smaller birds. The lighter material can be configured to withstand chewing by the relatively less powerful beaks of the smaller birds. The leash 102 can be configured to facilitate flight by a bird while withstanding tampering of the leash 102 by the bird.

In some variations, the leash 102 can include gradations of material from the central core of the material to the outer layer of the material. The different colored layers can facilitate notification to owners that their bird is chewing the leash 102 and when to replace the leash 192.

In some variations, the leash 102 can be formed from multiple types of material. Different elements of the leach 102 can be formed from different materials. Webbing-type material, which can have a high strength, can be used for the part of the leash 102 that will be closest to the harness and therefore closest to the bird. Webbing can be selected for the area of the leash 102 closest to the harness to make it harder for the bird to damage that area of the leash 102. For example, the harness end 104 of the leash 102 can be formed from a relatively strong webbing material. The handle end 106 of the leash 102 can be formed from a different material having different properties. The properties of the material toward the handle end 106 of the leash 102 can provide other benefits, for example, elasticity to absorb impacts, relatively lightweight to reduce the mass of the leash, and the like.

Making the leash 102 from different materials allows for the leash 102 to have different properties. For example, the weight of the leash 102 to be kept as low as possible while providing strength where it is necessary. Using elastic cord provides the benefit of having an elastic leash, thereby reducing impact forces on the board. For example, the elasticity of the cord can absorb impact shock thus preventing injury if a bird will unexpectedly try to take off, drop, or the like.

The leash 102 may be formed from a darker colored material. Birds have been shown to play or chew objects of brighter colors. Forming the leach 102 from material having a darker color can facilitate avoidance of chewing by the birds. For example, the leash can be formed from a low-key, unobtrusive black color.

The leash 102 can include a first loop 108 at a first end 104. The leash 102 can include a second loop 110 at a second end 106. The first loop 108 and the second loop 110 can be formed from different materials. The first loop 108 and the second loop 110 can have a different size. For example, the first loop 108 may be configured to be attached to a harness and have characteristics to facilitate attaching to a harness and for being closer to the bird. The second loop 110 can be configured to be held by a person or secured to an object to prevent the bird from flying away. The second loop 110 can be made from materials appropriate for holding by the owner. For example, the second loop 110 can be greater in size and can include hand grips to avoid the loop from cutting or digging into the owner's hand.

The first loop 108 can be smaller than the second look 110. The first loop 108 can be configured to attach to a bird harness. In some variations, the first loop 108 can be configured to attach to the bird harness via a pear-shaped quick link connector 112. The quick link connector 112 can include a locking mechanism 114. Quick link connectors 112 with locking mechanisms 114 have been found to be a particularly difficult connector for birds to open.

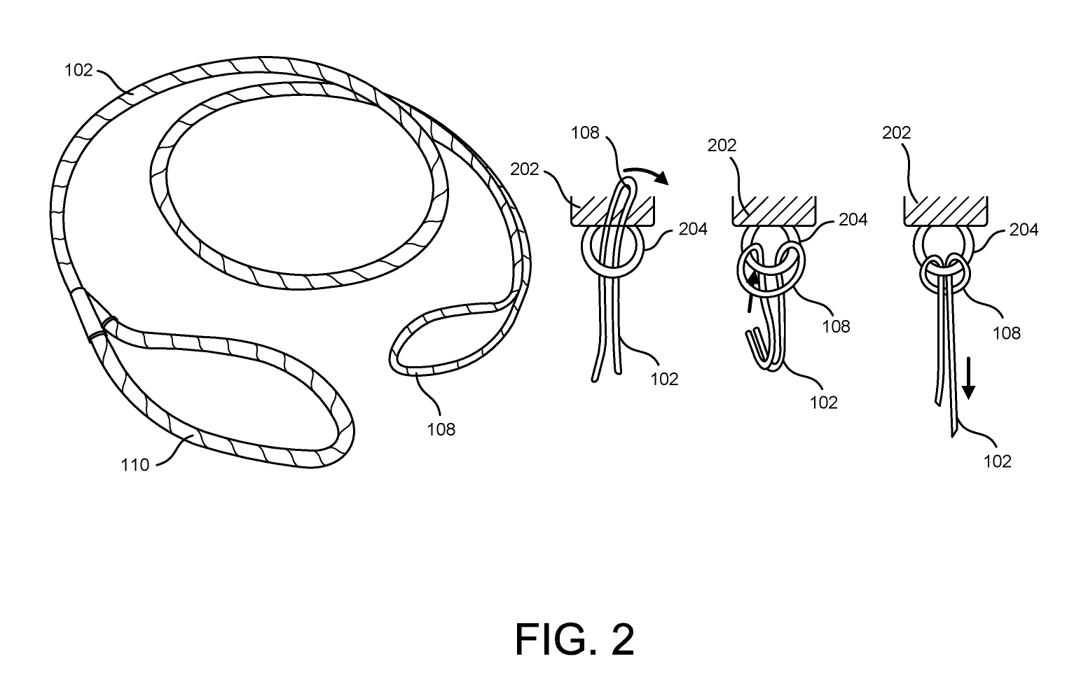

FIG. 2 is an illustration of a leash 102 having one or more elements consistent with the present disclosure. The leash 102 illustrated in FIG. 2 can facilitate attachment of the leash 102 to a harness 202 without the need for additional hardware. Pet birds are known to be mechanically minded. Pet birds, especially some of the larger species, have been known to work out how to undo hardware attachments between their harness 202 and the leash 102. As illustrated in FIG. 2 the first loop 108 of the leash 102 can be configured to fasten to the harness 292 using a knot. The knot can be, for example, a Lark's Head Knot, or the like.

In some variations, the leash 102 illustrated in FIG. 2 can include hardware for facilitating securing the leash 102 to the harness 202 or for providing additional strength for stronger birds. The hardware can include hardware that is safe for birds. For example, the hardware can be hardware that does not include zinc or lead. Heavy metal toxicity is a serious problem with birds that tend to “mouth” and chew on things. Special attention can be given to materials/parts used in the making of the harness and leash to make sure that it is as safe as possible for use with pet birds.

In some variations, the first loop 108 can be passed through a ring 204 of the harness 202 forming a loop on the opposite side of the ring 204 to the leash 102. The ring 204 can be a D-ring, or the like. The second loop 110 can then be passed through the first loop 108 and tightened, securing the leash 102 to the harness 202. In some variations, the leash 102 can be attached to the harness 202 directly, without the use of a ring. Attaching a leash 102 in this way can facilitate providing a removable leash 102 without the security risk associated with quick links that can be opened by some birds leading to their escape.

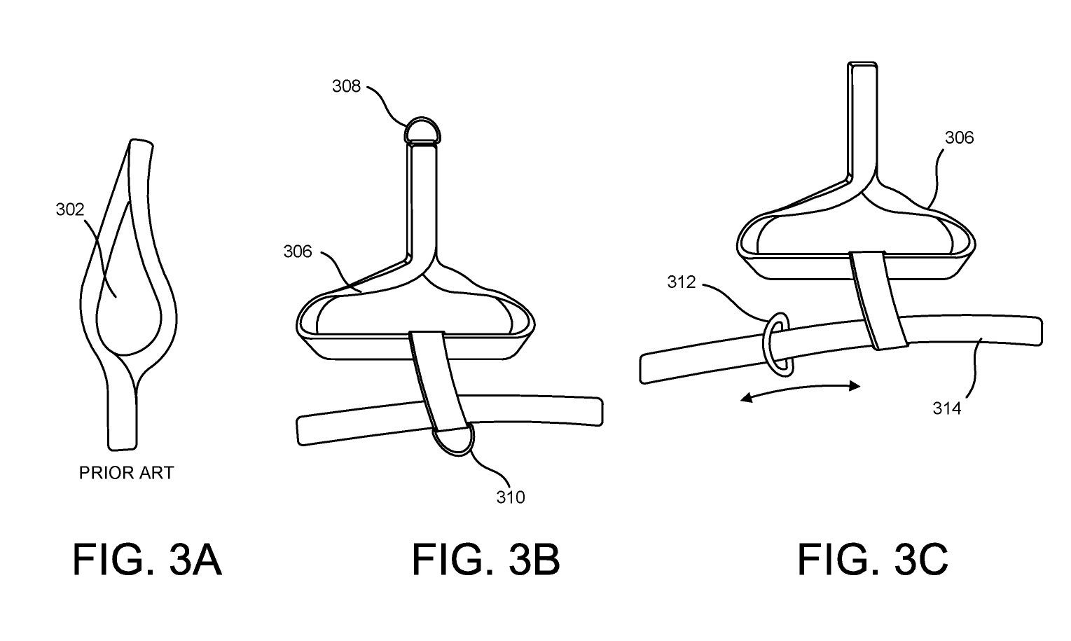

FIG. 3A is an illustration of an example of a prior art bird harness. Prior art designs of harnesses tend to include a V-shaped neck loop 302. The V-shaped neck loop 302 can cause tight fitting around the neck of the bird. Putting the harness on requires the neck loops 302 to be pulled over the head of the bird—which is with the natural growth of the feathers. However, when it is time to take the neck loop off, it is rubbing against the feathers which can result in feather damage, considerable discomfort and in some cases panicked birds and owners. If a bird is molting and has pin feathers, sometimes referred to as “blood feathers,” the act of pulling a neck loop over the head and forcing the pin feathers out of their natural growth path can be quite painful and potentially dangerous if any of the pin feathers break. Broken blood feathers can result in uncontrollable blood loss unless the damaged pin feather is pulled out. This procedure is generally recommended to be done by an avian veterinarian unless one has been trained in this procedure. Pulling anything tightly over the head, against the natural growth of a bird's plumage, is not recommended, particularly so if a bird is molting and has pin feathers on its neck and head area.

FIG. 3B is an illustration of a bird harness 304 having one or more features consistent with the present description. In some variations, the presently described bird harness 304 includes rounded head loop 306. The rounded head loop can be configured to be flexible. The shape of birds' heads vary greatly. What is comfortable for some birds, may not be so much for others. The harness 304 illustrated in FIG. 3B includes a reversible head loop 306 to provide bird owners with options to best suit their bird.

Some prior art harnesses require at least one wing of the bird to be pulled through a wing loop. Many birds will not tolerate this, causing distress and potential damage to the bird and owner. The harness 304 can be configured to facilitate installation on a bird without the need to pull a wing through a wing loop.

The harness 304 illustrated can comprise a front leash attachment point 308 and a rear leash attachment point 310. Each placement of leash attachment points can have advantages. For example, the advantage of either attachment point can be dependent on what a bird is doing at the time. If the bird is walking on the floor or if the leash 102 is used for fight training, the leash 102 is best attached to the back leash attachment point 310. If a bird is perching on someone's arm, the leash 102 is best attached to the front attachment point 308 so that the leach 102 can hang down between a bird's feet rather than laying across its lower back.

FIG. 3C illustrates a bird harness 304 having one or more elements consistent with the present description. In some variations, the bird harness 304 can include a freely sliding ring 312. The freely sliding ring 312 can be a D-Ring. The freely sliding ring 312 can be disposed on the abdomen belt 314. The ring 312 can be configured to move to an optimal position along the length of the abdomen belt 314. The bird harness 304 with the freely sliding ring 312 can facilitate self-adjustment of the leash-harness attachment point in response to a pet's movements. In some variations, the abdomen belt 314 can comprise two parallel materials. The ring 312 can be positioned within the parallel materials. The present harness allows attachment of the leash to either attachment point to maximize usability and comfort for a bird.

The harness 304 can include a two-color harness design. The two-color harness design can facilitate placement of the harness on the bird. For example, the harness can include an abdomen belt 314 having a first color. The abdomen belt 314 can be configured to wrap around the lower part of the body of the bird. In one example, the first color can be black, a generally dark color, or the like. The head loop 306 can be a second color. The head loop 306 can be placed over the birds head and rest around the bird's neck.

The head loop 306 of the harness can be removably attached to the abdomen belt 314. A removable head loop 306 can facilitate matching different sized head loops 306 with different sized abdomen belts 315 to provide a custom fit harness 304 for the bird. A removable head loop 306 can facilitate replacing worn or broken parts of the harness 304. A removable head loop 306 can facilitate easily putting the harness 304 onto the bird and taking it off. A removable head loop 306 can facilitate purchase of different colored head loops 306 as desired.

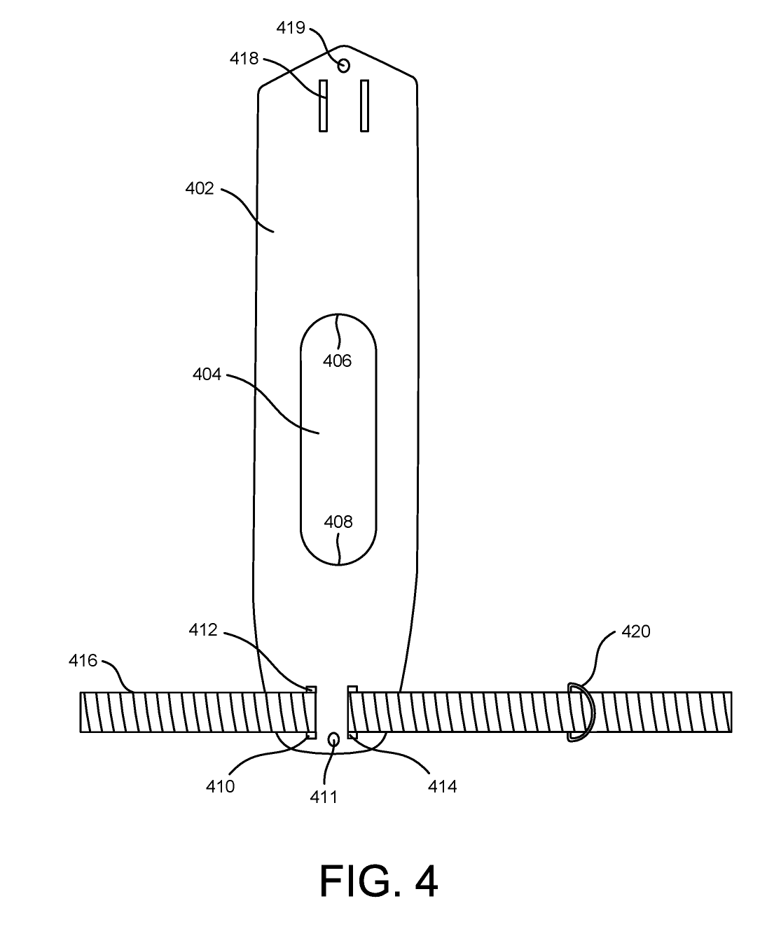

FIG. 4 is an illustration of a bird harness 402 having one or more features consistent with the present description. The bird harness 402 can include a rounded head loop 404. The rounded head loop 404 can be configured to cup a crop of a bird rather than crisscross a crop of a bird. The head loop 404 can include a first rounded portion 406 and a second rounded portion 408 opposite the first rounded portion 406.

The bird harness 402 can include a first abdomen belt attachment 410 at a first end 411 of the bird harness 402. The abdomen belt attachment 410 can include a first aperture 412 and a second aperture 414. The first aperture 412 and the second aperture 414 can be configured to receive an abdomen belt 416. The bird harness 402 can include a second abdomen belt attachment 418 at a second end 419 of the bird harness 402. The bird harness 402 can be reversible. The bird harness 402 can be configured to be worn by birds having different shapes and sizes.

The abdomen belt 416 can include a leash attachment ring 420. The leash attachment ring 420 can be a D-ring or the like. The leash attachment ring 420 can be configured to slide along the abdomen belt 416. The sliding leash attachment ring 420 can be configured to facilitate movement of a leash attached to the ring 420 from front to back as the bird moves or flies. A leash can be attached to the ring 420 using one or more of knots, quick links, or the like.

The harness 402 can include at first attachment point 422 at a first end 411 and a second attachment point 424 at a second end 424. The first attachment point 422 and the second attachment point 424 can be configured to facilitate attaching a leash to the harness 402.

The harness 402 can be formed from one or more of leather, pleather, fleece, webbing, or the like. The harness 402 can be formed from a material selected based on one or more properties indicative that the material is suitable to be placed on a bird. The abdomen belt 416 can be made from one or more of webbing, leather, pleather, fleece, or the like.

The material selected for the harness 402 and/or the abdomen belt 416 can be selected based on the requirements of the harness. For example, for large birds, heavy-duty, higher weight materials may be selected. For smaller birds, lighter-duty, lighter weight materials may be selected.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A harness for a bird comprising:
a body portion, the body portion having neck aperture configured to receive a head of a bird, the body portion have a first rounded portion and a second rounded portion opposite the second rounded portion;
an abdomen belt configured to circle an abdomen of a bird and secure the body portion to the bird;
a first abdomen belt aperture disposed at a first end of the body portion configured to secure the abdomen belt to the body potion;
a second abdomen belt aperture disposed at a second end of the body portion configured to secure the abdomen belt to the body portion; and
a leash attachment point configured to facilitate attachment of a leash to the harness.

2. The harness of claim 1, wherein the body portion is formed from a single piece of material.

3. The harness of claim 1, wherein the leash attachment point includes a ring.

4. The harness of claim 3, wherein the ring is configured to slide along the abdomen belt.

5. The harness of claim 1, wherein the body portion is configured to cup a crop of a bird.

6. The harness of claim 1, wherein the body portion is reversible.

7. The harness of claim 1, further comprising:
a leash.

8. The harness of claim 7, wherein the leash if formed from at least parachute cord.

9. The harness of claim 7, wherein the leash is formed from at least webbing.

10. The harness of claim 7, wherein the leash has at least a core having a first color and an outer layer having a second color different from the first color.

11. The harness of claim 7, wherein the leash is configured to attach to the harness using a knot.

12. The harness of claim 7, further comprising:
a mechanical connector configured to connect the leash to the harness.

13. The harness of claim 7, wherein the leash comprises:
a first loop at a first end of the leash, the first loop configured to attach to the harness; and
a second loop at a second end of the leash opposite the first end, the second loop configured to be a handle.

14. The harness of claim 1, further comprising:
a head loop.

15. The harness of claim 14, wherein the head loop is removable.
